(19) United States
(12) Patent Application Publication
(10) Pub. No.: US 2026/0313208 A1
(43) Pub. Date: Oct. 8, 2026

(54) VIDEO GENERATION METHOD AND APPARATUS, AND DEVICE, MEDIUM AND PROGRAM PRODUCT

(71) Applicant: Beijing Zitiao Network Technology Co., Ltd., Beijing (CN)

(72) Inventor: Tao ZHANG, Beijing (CN)

(21) Appl. No.: 19/490,206

(22) PCT Filed: Jun. 4, 2024
(86) PCT No.: PCT/CN2024/097380

§ 371 Date: Dec. 4, 2025

(30) Foreign Application Priority Data
Jun. 13, 2023 (CN) 202310701132.6

(51) Int. Cl. H04N 21/85; G06F 16/783; G06F 40/30

(52) U.S. Cl. CPC H04N 21/85; G06F 16/783; G06F 40/30

(57) ABSTRACT

The present disclosure provides a video generation method and apparatus, a device, a storage medium, and a program product. The method comprises: obtaining input data, the input data includes at least one of audio data or text data; performing feature extraction on the input data to obtain an input feature of the input data; determining a target video feature based on the input feature; and generating a target video based on the target video feature.

### CROSS-REFERENCE TO RELATED APPLICATION(S)

The present application claims priority to Chinese Patent Application No. 202310701132.6, filed with the China National Intellectual Property Administration on Jun. 13, 2023 and entitled “VIDEO GENERATION METHOD AND APPARATUS, AND DEVICE, MEDIUM AND PROGRAM PRODUCT”, which is incorporated herein by reference in its entirety.

### FIELD

The present disclosure relates to the field of computer technologies, and in particular, to a video generation method and apparatus, a device, a medium, and a program product.

### BACKGROUND

Multi-modal-to-video generation may guide video generation through data in other modalities such as text and voice. However, the existing multi-modal video generation technology does not have high accuracy of matching between different modalities, resulting in low accuracy of video generation, which reduces user experience.

### SUMMARY

The present disclosure proposes a video generation method and apparatus, a device, a storage medium, and a program product, to solve the technical problem of low accuracy of video generation to a certain extent.

According to a first aspect of the present disclosure, there is provided a video generation method, including:
obtaining input data, where the input data includes at least one of audio data or text data;
obtaining an input feature of the input data by performing feature extraction on the input data;
determining a target video feature based on the input feature; and
generating a target video based on the target video feature.

According to a second aspect of the present disclosure, there is provided a video generation apparatus, including:
an obtaining module, configured to obtain input data, where the input data includes audio data or text data;
an extraction module, configured to obtain an input feature of the input data by performing feature extraction on the input data;
a matching module, configured to determine a target video feature based on the input feature; and
a generation module, configured to generate a target video based on the target video feature.

According to a third aspect of the present disclosure, there is provided an electronic device, including one or more processors and a memory; and one or more programs, where the one or more programs are stored in the memory and executed by the one or more processors, and the program includes instructions used to perform the method according to the first aspect or the second aspect.

According to a fourth aspect of the present disclosure, there is provided a non-volatile computer-readable storage medium including a computer program, and the computer program, when executed by one or more processors, causes the processors to perform the method according to the first aspect or the second aspect.

According to a fifth aspect of the present disclosure, there is provided a computer program product including computer program instructions, and the computer program instructions, when executed on a computer, cause the computer to perform the method according to the first aspect.

As can be seen from the above, according to the video generation method and apparatus, the device, the medium, and the program product provided by the present disclosure, a corresponding target video feature is determined based on an input feature of input data, to generate a target video.

### BRIEF DESCRIPTION OF THE DRAWINGS

In order to more clearly describe the technical solutions in the present disclosure or in the related art, the accompanying drawings for describing the embodiments or the related art will be briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of a video generation architecture according to an embodiment of the present disclosure;

FIG. 2 is a schematic structural diagram of hardware of an exemplary electronic device according to an embodiment of the present disclosure;

FIG. 3 is a schematic flowchart of a video generation method according to an embodiment of the present disclosure;

FIG. 4 is a schematic diagram of a video generation method according to an embodiment of the present disclosure; and

FIG. 5 is a schematic diagram of a video generation apparatus according to an embodiment of the present disclosure.

### DETAILED DESCRIPTION OF EMBODIMENTS

In order to make the objects, technical solutions, and advantages of the present disclosure clearer, the present disclosure is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include”, “comprise”, or like words mean that an element or item preceding the term encompasses an element or item or its equivalent listed after the term, without excluding other elements or items. “Connection”, “mutual connection”, or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. In addition, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

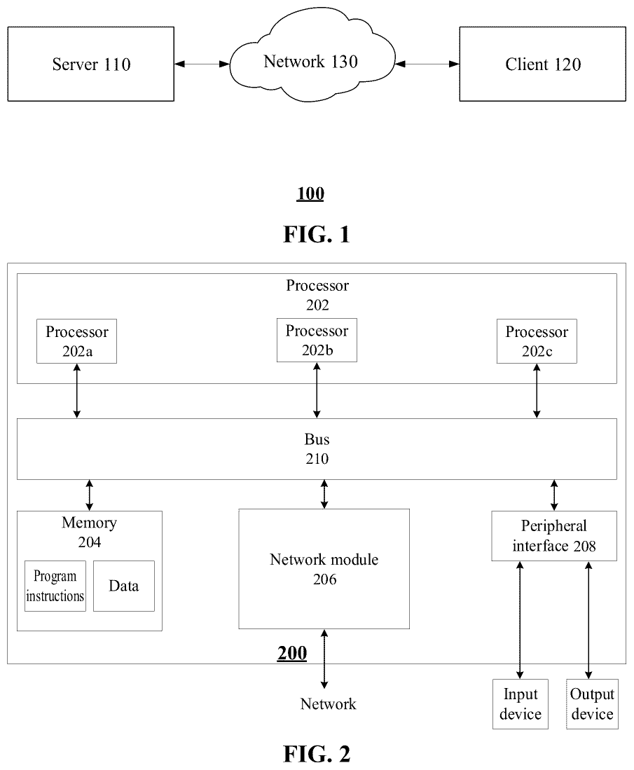

FIG. 1 is a schematic diagram of a video generation architecture according to an embodiment of the present disclosure. Referring to FIG. 1, the video generation architecture 100 may include a server 110, a terminal 120, and a network 130 providing a communication link. The server 110 and the terminal 120 may be connected via a wired or wireless network 130. The server 110 may be a stand-alone physical server, or a server cluster or a distributed system that includes a plurality of physical servers, or a cloud server that provides basic cloud computing services, such as cloud services, cloud databases, cloud computing, cloud functions, cloud storage, network services, cloud communication, middleware services, security services, and CDN.

The terminal 120 may be implemented in hardware or software. For example, when the terminal 120 is implemented in hardware, the terminal may be various electronic devices having a display screen and supporting page display, including, but not limited to, a smart phone, a tablet computer, an e-book reader, a laptop portable computer, a desktop computer, etc. When the terminal device 120 is implemented in software, the terminal devices listed above may be installed on the electronic devices listed above. The terminal devices may be implemented as a plurality of pieces of software or software modules (such as a plurality of pieces of software or software modules configured to provide distributed services), or may be implemented as a single piece of software or software module. The terminal devices are not specifically limited here.

It should be noted that a video generation method provided in embodiments of the present application may be executed by the terminal 120 or by the server 110. It should be understood that the numbers of terminals, networks, and servers in FIG. 1 are merely illustrative, and are not intended to be limiting. According to implementation needs, there may be any number of terminals, networks, and servers.

FIG. 2 is a schematic structural diagram of hardware of an exemplary electronic device 200 according to an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are communicatively connected to each other within the electronic device 200 through the bus 210.

The processor 202 may be a central processing unit (CPU), a video generator, a neural processing unit (NPU), a microcontroller unit (MCU), a programmable logic device, a digital signal processor (DSP), an application-specific integrated circuit (ASIC), or one or more integrated circuits. The processor 202 may be configured to perform functions related to the technology described in the present disclosure. In some embodiments, the processor 202 may alternatively include a plurality of processors integrated into a single logical component. For example, as shown in FIG. 2, the processor 202 may include a plurality of processors 202a, 202b, and 202c.

The memory 204 may be configured to store data (e.g., instructions and computer code). As shown in FIG. 2, the data stored in the memory 204 may include program instructions (e.g., program instructions for implementing the video generation method in the embodiments of the present disclosure) and data to be processed (e.g., the memory may store configuration files for other modules). The processor 202 may also access the program instructions and the data stored in the memory 204 and execute the program instructions to operate the data to be processed. The memory 204 may include a volatile storage apparatus or a non-volatile storage apparatus. In some embodiments, the memory 204 may include a random-access memory (RAM), a read-only memory (ROM), an optical disk, a magnetic disk, a hard drive, a solid state drive (SSD), a flash memory, a memory stick, etc.

The network module 206 may be configured to provide communication between the electronic device 200 and other external devices via a network. The network may be any wired or wireless network capable of transmitting and receiving data. For example, the network may be a wired network, a local wireless network (e.g., Bluetooth, Wi-Fi, and near field communication (NFC)), a cellular network, the Internet, or a combination of the above. It should be understood that the type of network is not limited to the above specific examples. In some embodiments, a network module 306 may include any combination of any number of network interface controllers (NICs), radio frequency modules, transceivers, modems, routers, gateways, adapters, cellular network chips, etc.

The peripheral interface 208 may be configured to connect the electronic device 200 with one or more peripheral apparatuses to achieve information input and output. For example, the peripheral apparatus may include an input device such as a keyboard, a mouse, a touchpad, a touchscreen, a microphone, and various sensors, and an output device such as a display, a speaker, a vibrator, and an indicator light.

The bus 210 may be configured to transmit information between various components of the electronic device 200 (e.g., the processor 202, the memory 204, the network module 206, and the peripheral interface 208), such as an internal bus (e.g., a processor-memory bus) and an external bus (a USB port and a PCI-E bus).

It should be noted that although only the processor 202, the memory 204, the network module 206, the peripheral interface 208, and the bus 210 are shown in the architecture of the above electronic device 200, during a specific implementation, the architecture of the electronic device 200 may further include other components necessary for normal operation. In addition, those skilled in the art should understand that the architecture of the electronic device 200 may include only components necessary for implementing the solutions of the embodiments of the present disclosure, and does not necessarily include all the components shown in the figures.

In existing video generation technology, cross-modal matching technology is generally relied upon to solve matching problems between data of different modalities, such as video, audio, text, compression encoding, etc. However, the accuracy of matching between different modalities in the prior art is not high, resulting in low accuracy of a video generated based on an input of a user and failing to meet requirements of the user. Therefore, how to improve the accuracy of video generation has become a technical problem that needs to be solved urgently.

In view of this, embodiments of the present disclosure provide a video generation method and apparatus, a device, a storage medium, and a program product. A corresponding target video feature is determined based on an input feature of input data, to generate a target video. Regardless of a modality of the input data, matching with the video feature can always be implemented to accurately generate the target video, thus improving the accuracy of video generation.

Specifically, a user may input a piece of text data, e.g., a segment of lyrics, and wants to generate a video corresponding to the segment of lyrics, e.g., an MV. According to the video generation method of the embodiments of the present disclosure, feature extraction may be performed on the text data to obtain a text feature. A target video feature that matches the text feature is then determined based on the text feature. Then generating a corresponding target video based on the target video feature can improve the accuracy of cross-modal matching between a text modality and a video modality, thereby improving the accuracy of the generated target video.

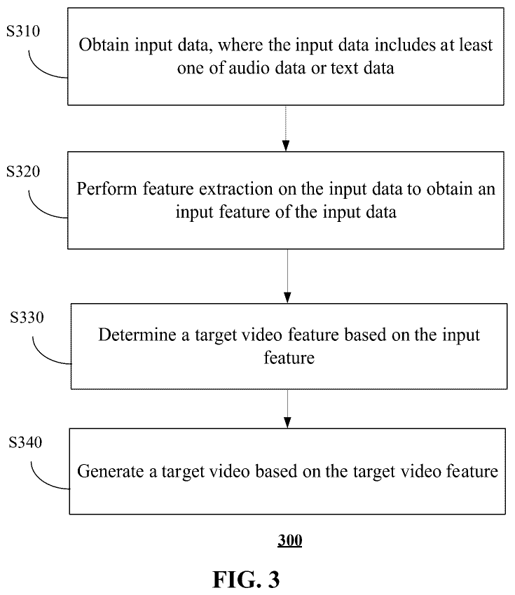

Referring to FIG. 3, FIG. 3 is a schematic flowchart of a video generation method according to an embodiment of the present disclosure. In FIG. 3, a video generation method 300 may further include the following steps.

At step S310, input data is obtained, where the input data includes at least one of audio data or text data.

The input data may be data directly input or determined by a user through a user operation by using an interaction interface. For example, the user may input text data, audio data, or video data directly, or may select text data, audio data, or video data, and then obtain the data via the network, and if the user selects the video data, the user obtains audio data or text data in the video data. In some embodiments, the input data may come from a same data source, e.g., same audio or video data; or may come from different data sources.

At step S320, feature extraction is performed on the input data to obtain an input feature of the input data.

In some embodiments, the input data may include at least one input data slice. Input data slicing is to slice text data, audio data, or video data input by a user into segments. The segment may include single semantic data with a single semantic property. In an aspect, the input data slicing may slice long input data into short input data, to provide the basis for parallelization acceleration. In another aspect, the input data slicing slices the input data into segments with a single meaning, avoiding semantic confusion caused by data segments that contain a plurality of meanings in a same segment of data when feature matching is performed.

In some embodiments, performing feature extraction on the input data to obtain an input feature of the input data includes:
slicing the input data to obtain single semantic data; and
obtaining a plurality of input features corresponding to the input data based on the single semantic data.

The input data usually includes data segments having a plurality of meanings, and directly performing feature extraction on the data segments having a plurality of meanings may cause semantic confusion and reduce the quality of a final generated video. For example, for the text data “text1, text2”, text1 and text2 have respective meanings, and treating them as one piece of data for feature extraction may cause semantic confusion. To solve the problem of semantic confusion, one piece of multi-semantic data may be split into a plurality of pieces of single semantic data, e.g., the text data “text1, text2” is split into two pieces of single semantic data “text1” and “text2” for feature extraction, to obtain two input features F_text1 and F_text2. Performing subsequent feature matching based on the input features F_text1 and F_text2 may then avoid the semantic confusion caused by semantic crossover between each other and can effectively improve the quality of semantic matching. For example, “the sunlit Censer Peak exhales incense-like cloud; the cataract hangs like upended stream, sounding loud” may be split into “the sunlit Censer Peak exhales incense-like cloud” and “the cataract hangs like upended stream, sounding loud”. It should be understood that the slicing of the input data described above is merely an example and is not intended to limit a modality of the input feature and a number of pieces of single semantic data obtained from the slicing, and the input data may include at least one of text data, audio data, or video data, and may include less or more single semantic data after the slicing, which is not limited here.

In some embodiments, obtaining a plurality of input features corresponding to the input data based on the single semantic data further includes:
performing multi-modal feature extraction processing on the single semantic data to obtain the input feature.

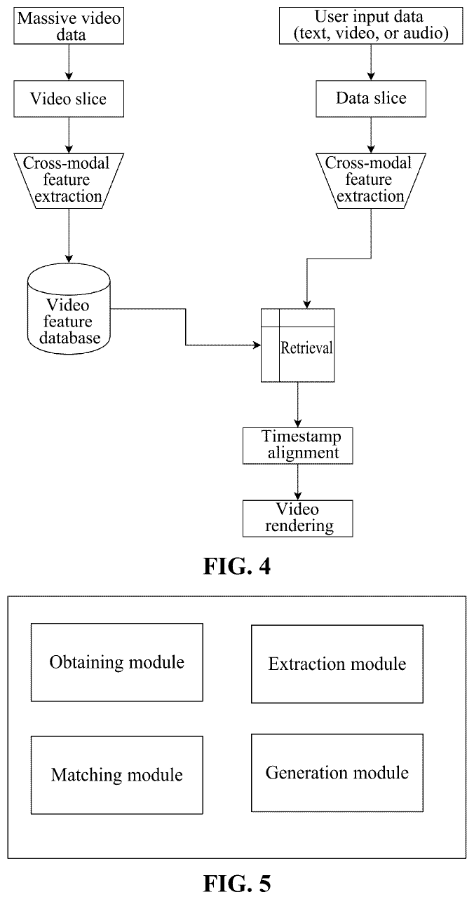

Specifically, referring to FIG. 4, FIG. 4 is a schematic diagram of a video generation method according to an embodiment of the present disclosure. In FIG. 4, when performing feature extraction on the input data, the feature extraction processing method used is consistent with that used when obtaining a video feature library, e.g., such that feature extraction may be performed on the input data by a feature extraction network obtaining video features in the video feature library. Feature extraction is to extract a feature vector from a single semantic data segment, thereby effectively reducing a dimension of data.

At step S330, a target video feature is determined based on the input feature.

The input feature may be a feature of a text modality or an audio modality, and feature matching may be performed in a video feature library based on the input feature to determine a matching target video feature from the video feature library, as shown in FIG. 4. The video feature library may include a plurality of video features, and the video features may have corresponding semantic properties. The semantics of the input feature may be matched with the semantics of the video features to determine the target video feature in the video features. Further, the video feature library may further include a text feature corresponding to a video feature.

In some embodiments, determining a target video feature based on the input feature includes:
calculating semantic relatedness between the input feature and a video feature in a video feature library; and
determining a video feature with the highest semantic relatedness as the target video feature.

Specifically, the semantic relatedness may be obtained by calculating a cosine distance based on the input feature and all video features in the video feature library, and a video feature corresponding to a minimum cosine distance is selected as a matching result.

In some embodiments, the method 300 may further include:
performing multi-modal feature extraction based on a plurality of pieces of video data to obtain a plurality of video features with semantic properties.

The plurality of video features form the video feature library. Video data may also be pre-classified based on an attribute such as a theme, a style, etc., which may provide a data basis for generating videos of different themes and styles when generating subsequent target videos. Multi-modal feature extraction may be performed for each piece of video data, e.g., feature extraction may be performed on the video data by a multi-modal feature extraction network to obtain video features with semantics. Since it is required to retrieve and match with data in other modalities such as text, audio, etc., subsequently, it is not feasible to obtain a single-modal feature set by using a single-modal video feature extractor as in the prior art. A multi-modal feature set may be updated continuously in subsequent use, and there is no need to rebuild a database for each feature matching. It should be understood that the method for performing feature extraction on the input data is consistent with the feature extraction method for obtaining a multi-modal feature.

At step S340, a target video is generated based on the target video feature.

The target video feature has a corresponding video segment, and the corresponding target video may be generated based on the target video feature.

In some embodiments, generating a target video based on the target video feature includes:
determining a corresponding target video slice based on the target video feature;
aligning a target timestamp of the target video slice with a source timestamp of the input data to obtain an aligned target video slice; and
stitching the aligned target video slice based on the source timestamp to obtain the target video.

The target video feature corresponds to each input feature, that is, corresponds to each input data slice (i.e., single semantic data). After the corresponding target video slice is retrieved for each input data slice, it is required to combine these target video slices into a complete video. However, timestamps of the input data and the matched target video slices are not always aligned, thus it is required to align the timestamps of the two and then stitch the target video slices to obtain the final target video.

In some embodiments, when the input data is text data, the source timestamp of the text data may be set based on a preset playback speed.

For input data that has a timestamp itself, e.g., audio data, its own timestamp may be used as the source timestamp. For input data that does not have a timestamp itself, e.g., text data, a corresponding timestamp may be set for the input data. Specifically, for the text data text, the text data may be played based on a preset playback speed v, e.g., the text data text includes a plurality of text data segments text1, text2, . . . , texti, . . . , with corresponding data lengths L1, L2, . . . , Li, . . . , respectively, thus the text data segment text1 has a start timestamp of 0 and an end timestamp of L1/v, the text data segment text2 has a start timestamp of L1/v and an end timestamp of (L1+L2)/v, and a timestamp may be set for the text data text by analogy. It should be understood that the timestamps described above are merely examples and are not intended to limit the timestamps, and the set timestamps may or may not include a start timestamp and/or an end timestamp, or may include timestamps at other locations, which is not limited here.

In some embodiments, aligning a target timestamp of the target video slice with a source timestamp of the input data to obtain an aligned target video slice further includes:
obtaining a target duration of the target video slice based on the target timestamp, and obtaining a source duration of the input data slice based on the source timestamp; and
aligning the target timestamp with the source timestamp based on the target duration and the source duration to obtain the aligned target video slice.

In some embodiments, aligning the target timestamp with the source timestamp based on the target duration and the source duration to obtain the aligned target video slice includes:
using a target video slice having the target duration equal to the source duration directly as an aligned target video slice;
cropping a target video slice having the target duration greater than the source duration to obtain an aligned target video slice; or
performing frame-interpolation extension on a target video slice having the target duration less than the source duration to obtain an aligned target video slice.

Specifically, target video slices may be processed one by one in sequence to align the timestamp of the target video slice with the timestamp of the input data slice. Taking a start timestamp s1 and an end timestamp s2 of an input data slice S and a start timestamp t1 and an end timestamp t2of a target video slice T as an example:
if a source duration s2−s1=a target duration t2−t1, the target video slice T is filled into a time period s1s2 corresponding to the input data slice S as a matching result.

If the source duration s2−s1<the target duration t2−t1, the target video slice T is cropped so that a duration t2′−t1′ of a cropped target video slice T′=the source duration s2−s1, and the cropped target video slice T′ is filled into the time period s1s2 corresponding to the input data slice S as a matching result.

If the source duration s2−s1>the target duration t2−t1, frame-interpolation extension is performed on the target video slice T so that the duration t2′−t1′ of the target video slice T′ after frame-interpolation extension=s2−s1, and the target video slice T′ after frame-interpolation extension is filled into the time period s1s2 corresponding to the input data slice S as a matching result.

Specifically, after matching and timestamp adjustment for alignment of all target video slices are completed, all target video slices may be arranged in the order of the timestamps of the input data, and these target video slices may be rendered into the final target video.

In some embodiments, the input data may further include indication information for indicating an attribute of a target video. In some embodiments, the determining a target video feature based on the input feature includes:
determining a target video feature from video features having the attribute in a video feature library by matching the input feature with the video features.

The attribute may include a style, a theme, etc. For example, the style may include a funny style, a classical style, etc.; and the theme may include a natural theme, an animal theme, etc. A user may indicate an attribute such as a style or a theme of the generated target video by input data. For example, the user inputs a piece of video data A with a style F1. The indication information includes that a style of the target video is F2, and then the target video generated according to an embodiment of the present disclosure is obtained by changing the style of the video data A to F2.

It should be noted that the method in the embodiments of the present disclosure may be performed by a single device, such as a computer or a server. The method in the embodiments may also be applied to a distributed scenario to be completed through cooperation of a plurality of devices. In the distributed scenario, one of the plurality of devices may perform only one or more steps of the method in the embodiments of the present disclosure. The plurality of devices interact with each other to complete the method.

It should be noted that some embodiments of the present disclosure are described above. Other embodiments are within the scope of the appended claims. In some cases, the actions or steps recited in the claims can be performed in an order different from that in the above embodiments, and can still achieve desired results. In addition, the processes depicted in the accompanying drawings are not necessarily required to be shown in a particular or sequential order, to achieve desired results. In some implementations, multi-task processing and parallel processing are also possible or may be advantageous.

Based on the same technical concept, corresponding to the method in any one of the embodiments described above, the present disclosure further provides a video generation apparatus. Referring to FIG. 5, the video generation apparatus includes:
an obtaining module, configured to obtain input data, where the input data includes at least one of audio data or text data;
an extraction module, configured to perform feature extraction on the input data to obtain an input feature of the input data;
a matching module, configured to determine a target video feature based on the input feature; and
a generation module, configured to generate a target video based on the target video feature.

For ease of description, when described, the above apparatus is divided into various modules based on functions. Certainly, functions of the modules may be implemented in one or more pieces of software and/or hardware when the present disclosure is implemented.

The apparatus in the foregoing embodiment is configured to implement the corresponding video generation method in any one of the embodiments described above, and has the beneficial effects of the corresponding method embodiment, which are not repeated herein.

Based on the same technical concept, corresponding to the method in any one of the foregoing embodiments, the present disclosure further provides a non-transitory computer-readable storage medium storing computer instructions, where the computer instructions are used to cause a computer to perform the video generation method in any one of the foregoing embodiments.

The computer-readable medium in this embodiment includes permanent and non-permanent, removable and non-removable media and may implement information storage by using any method or technology. Information may be computer-readable instructions, data structures, modules of a program, or other data. Examples of the computer storage medium include but are not limited to a phase-change random-access memory (PRAM), a static random-access memory (SRAM), a dynamic random-access memory (DRAM), other types of random-access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, magnetic tape or disk storage or other magnetic storage devices, or any other non-transmission media that may be configured to store information capable of being accessed by a computing device.

The computer instructions stored on the storage medium in the foregoing embodiment are used to cause the computer to perform the video generation method in any one of the foregoing embodiments, and have the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood KWM by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the above description. For example, the discussed embodiments may be used for other memory architectures (e.g., a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements etc., made within the spirit and principle of the embodiments of the present disclosure are intended to be included within the scope of protection of the present disclosure.

1. A video generation method, comprising:
obtaining input data, the input data comprising at least one of audio data or text data;
obtaining an input feature of the input data by performing feature extraction on the input data
determining a target video feature based on the input feature; and
generating a target video based on the target video feature.

2. The method according to claim 1, wherein the obtaining the input feature of the input data by performing feature extraction on the input data comprises:
obtaining single semantic data by slicing the input data; and
obtaining a plurality of input features corresponding to the input data based on the single semantic data.

3. The method according to claim 1, wherein the determining the target video feature based on the input feature comprises:
calculating semantic relatedness between the input feature and a video feature in a video feature library; and
determining a video feature with the highest semantic relatedness as the target video feature.

4. The method according to claim 1, wherein the generating the target video based on the target video feature comprises:
determining a corresponding target video slice based on the target video feature;
obtaining an aligned target video slice by aligning a target timestamp of the target video slice with a source timestamp of the input data; and
obtaining the target video by stitching the aligned target video slice based on the source timestamp.

5. The method according to claim 4, wherein the input data comprises at least one single semantic data; and
obtaining the aligned target video slice by aligning a target timestamp of the target video slice with a source timestamp of the input data further comprises:
obtaining a target duration of the target video slice based on the target timestamp, and obtaining a source duration of the single semantic data based on the source timestamp; and
obtaining the aligned target video slice by aligning the target timestamp with the source timestamp based on the target duration and the source duration.

6. The method according to claim 5, wherein obtaining the aligned target video slice by aligning the target timestamp with the source timestamp based on the target duration and the source duration comprises:
using a target video slice having the target duration equal to the source duration directly as the aligned target video slice; or
obtaining the aligned target video slice by cropping a target video slice having the target duration greater than the source duration; or
obtaining the aligned target video slice by performing frame-interpolation extension on a target video slice having the target duration less than the source duration.

7. The method according to claim 1, wherein the input data further comprises indication information for indicating an attribute of the target video; and
determining the target video feature based on the input feature comprises:
determining a target video feature from video features having the attribute in a video feature library by matching the input feature with the video features.

8. The method according to claim 1, wherein the input data is text data, and the method further comprises: setting a source timestamp of the text data based on a preset playback speed.

9. (canceled)

10. An electronic device, comprising a memory, a processor, and a computer program stored on the memory and executable on the processor, wherein the computer program, when executed by the processor, causes the processor to:
obtain input data, the input data comprising at least one of audio data or text data;
obtain an input feature of the input data by performing feature extraction on the input data determine a target video feature based on the input feature; and
generate a target video based on the target video feature.

11. A non-transitory computer-readable storage medium storing computer instructions, wherein the computer instructions are used to cause a computer to:
obtain input data, the input data comprising at least one of audio data or text data;
obtain an input feature of the input data by performing feature extraction on the input data determine a target video feature based on the input feature; and
generate a target video based on the target video feature.

12. (canceled)

13. The electronic device according to claim 10, wherein the computer program causing the processor to obtain the input feature of the input data by performing feature extraction on the input data comprises instructions to:
obtain single semantic data by slicing the input data; and
obtain a plurality of input features corresponding to the input data based on the single semantic data.

14. The electronic device according to claim 10, wherein the computer program causing the processor to determine the target video feature based on the input feature comprises instructions to:
calculate semantic relatedness between the input feature and a video feature in a video feature library; and
determine a video feature with the highest semantic relatedness as the target video feature.

15. The electronic device according to claim 10, wherein the computer program causing the processor to generate the target video based on the target video feature comprises instructions to:
determine a corresponding target video slice based on the target video feature;
obtain an aligned target video slice by aligning a target timestamp of the target video slice with a source timestamp of the input data; and
obtain the target video by stitching the aligned target video slice based on the source timestamp.

16. The electronic device according to claim 15, wherein the input data comprises at least one single semantic data; and the computer program causing the processor to obtain the aligned target video slice by aligning a target timestamp of the target video slice with a source timestamp of the input data further comprises instructions to:
obtain a target duration of the target video slice based on the target timestamp, and obtain a source duration of the single semantic data based on the source timestamp; and
obtain the aligned target video slice by aligning the target timestamp with the source timestamp based on the target duration and the source duration.

17. The electronic device according to claim 16, wherein the computer program causing the processor to obtain the aligned target video slice by aligning the target timestamp with the source timestamp based on the target duration and the source duration comprises instructions to:
use a target video slice having the target duration equal to the source duration directly as the aligned target video slice; or
obtain the aligned target video slice by cropping a target video slice having the target duration greater than the source duration; or
obtain the aligned target video slice by performing frame-interpolation extension on a target video slice having the target duration less than the source duration.

18. The electronic device according to claim 10, wherein the input data further comprises indication information for indicating an attribute of the target video; and the computer program causing the processor to determine the target video feature based on the input feature comprises instructions to:
determine a target video feature from video features having the attribute in a video feature library by matching the input feature with the video features.

19. The electronic device according to claim 10, wherein the input data is text data, and the method further comprises: setting a source timestamp of the text data based on a preset playback speed.

20. The storage medium according to claim 11, wherein the computer instructions causing the computer to obtain an input feature of the input data by performing feature extraction on the input data comprises instructions to:
obtain single semantic data by slicing the input data; and
obtain a plurality of input features corresponding to the input data based on the single semantic data.

21. The storage medium according to claim 11, wherein the computer instructions causing the computer to determine the target video feature based on the input feature comprises instructions to:
calculate semantic relatedness between the input feature and a video feature in a video feature library; and
determine a video feature with the highest semantic relatedness as the target video feature.

22. The storage medium according to claim 11, wherein the computer instructions causing the computer to generate the target video based on the target video feature comprises instructions to:
determine a corresponding target video slice based on the target video feature;
obtain an aligned target video slice by aligning a target timestamp of the target video slice with a source timestamp of the input data; and
obtain the target video by stitching the aligned target video slice based on the source timestamp.
